(19) United States
(12) Patent Application Publication
(10) Pub. No.: US 2010/0170602 A1
(43) Pub. Date: Jul. 8, 2010

(54) PNEUMATIC TIRE AND METHOD OF CARRYING OUT HAND GROOVING ON THE SAME

(75) Inventor: Masaaki Ohara, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/641,475

(22) Filed: Dec. 18, 2009

(30) Foreign Application Priority Data
Jan. 6, 2009 (JP) 2009-001029

(51) Int. Cl. B60C 11/117; B29D 30/68

(52) U.S. Cl. 152/209.25; 157/13

(57) ABSTRACT

An object of the present invention is to provide a pneumatic tire on a tread surface of which hand grooving can be carried out swiftly and easily, and a method of carrying out the hand grooving thereon. In order to achieve the object, a pneumatic tire comprises a tread surface formed with a plurality of grooves. The tread surface includes a guide line previously disposed as a reference for carrying out hand grooving. The guide line extends along at least one edge line of the grooves or a virtual extension line of at least one edge line of the grooves.

### BACKGROUND OF THE INVENTION

1. Field of the Invention

The present invention relates to a pneumatic tire having a tread surface formed with a plurality of grooves and a method of carrying out hand grooving on the same, and is particularly useful for a pneumatic tire for motor racing and a method of carrying out the hand grooving on the same.

2. Description of the Related Art

Generally, in pneumatic tires used for motor racing, the area of the grooves formed in the tread surface has to be adjusted depending on racing conditions and/or weather. More particularly, for example, in a case where the weather is fine and the road surface is dry, the tread surface of the pneumatic tire to be used is set to have a groove area as small as possible. However, when racing/course conditions are changed due to a rain during racing or the like, the pneumatic tire may be formed with new grooves by carrying out so-called hand grooving manually or automatically on the tread surface of the pneumatic tire for motor racing by using, for example, a grooving machine, which is called a tire groover. With this hand grooving, necessary grooves are formed additionally in the tread surface of the pneumatic tire for motor racing depending on the racing/course conditions.

When the hand grooving is carried out, in order to form grooves at desired positions in the tread surface, guide lines as a reference have to be drawn in the tread surface. Conventionally, such guide lines are drawn manually in the tread surface using a pen or the like. However, since drawing the guide lines on the tread surface took a considerably long time, it was extremely difficult to carry out such hand grooving swiftly depending on racing/course conditions.

Japanese Unexamined Patent Publication No. 09-142106 discloses a pneumatic racing tire having a tread made of a rubber, of which JIS A hardness at 20° C. is 65 or less. The tread surface is formed with grooves for discharging water and is provided with projections protruding from the tread surface in an edge area along the grooves. In the pneumatic tire, by employing such a structure in which the tread surface is provided with the projections protruding from the tread surface along the grooves, even when the load increases at traction/braking, the grooves are hardly collapsed or twisted. Therefore, the cross sectional area of the groove is prevented from being reduced.

Japanese Unexamined Patent Publication No. 2001-55011 discloses a pneumatic radial tire constituted of a tread rubber of 2 to 6 mm in thickness having a tread surface in a smooth pattern with substantially no pattern. The tire has a tread surface provided with long protruding portions each having a fine cross section along the width direction of the tread at least on the tread surface. In this pneumatic tire, by employing a structure in which the tread surface is provided with the long protruding portions, partial wear and decrease in durability of the tire caused by rubber spews which are generated during forming and vulcanizing the tire.

Japanese Unexamined Patent Publication No. 2001-191741 discloses a pneumatic tire having a tread surface including a plurality of blocks. The surface of the blocks is formed with a plurality of sipes extending in the width direction of the tire. At least one groove shallower than the sipe is disposed between the sipes and/or between a sipe and a side end of the block, and the depth of the shallow groove is set to 0.5 mm or less. In this pneumatic tire, by employing a structure in which the shallow grooves are formed in the tread surface, running performance on iced road surfaces is improved.

Japanese Unexamined Patent Publication No. 2007-15621 discloses a pneumatic tire having a tread formed with many narrow grooves of 0.1 to 2.0 mm in width and 0.1 to 1.0 mm or less in depth on the surface of the tread. The narrow grooves each have a substantially rectangular shape in cross section. In this pneumatic tire, by employing a structure in which the shallow and narrow grooves are formed on the tread surface, braking performance during initial stage of application is improved.

However, the above-described patent publications do not give any suggestion to solve the aforementioned problems in drawing guide lines as a reference on the tread surface in order to form the grooves at desired positions in the tread surface.

### SUMMARY OF THE INVENTION

The present invention has been proposed in view of the above-described circumstances. It is an object of the present invention to provide a pneumatic tire on a tread surface of which hand grooving can be carried out swiftly and easily, and a method of carrying out the hand grooving thereon.

The above-mentioned object can be achieved by the present invention as follows. That is, the present invention provides a pneumatic tire comprising: a tread surface formed with a plurality of grooves, wherein the tread surface includes a guide line previously disposed as a reference for carrying out hand grooving, the guide line extending along at least one edge line of the grooves or a virtual extension line of at least one edge line of the grooves.

In the above pneumatic tire, the guide line is previously disposed on the tread surface as a reference for carrying out the hand grooving. The guide line extends along at least one edge line of the groove or a virtual extension line of at least one edge line of the grooves. In this arrangement, the hand grooving can be carried out swiftly and easily on the tread surface by utilizing the guide line as a reference in order to additionally form grooves on the tread surface. As a result, in the pneumatic tire, the groove can be additionally formed swiftly and easily at a desired position in the tread surface. In the present invention, the wording “hand grooving” means additionally forming grooves on a tread surface of an unused tire.

In the above pneumatic tire, it is preferred that the guide line is disposed on the virtual extension line. When carrying out the hand grooving in the tread surface of the pneumatic tire having such arrangement by utilizing the guide line as a reference, the additional groove can be easily communicated with an existing groove. Since the water discharge performance is particularly improved, improved are the braking performance on wet road surfaces (hereinafter, referred to as “wet braking performance”) and the cornering performance on wet road surfaces (hereinafter, referred to as “wet cornering performance”) of the pneumatic tire.

The present invention provides a pneumatic tire comprising: a tread surface formed with a plurality of grooves, wherein the grooves include two or more grooves each having at least one end terminated within the tread surface, the tread surface has a guide line previously disposed as a reference for carrying out hand grooving, the guide line extending along a virtual line connecting end points of at least one edge line in edge lines of the grooves with terminated ends.

In this pneumatic tire, the guide line is previously disposed on the tread surface as a reference for carrying out the hand grooving. The guide line extends along a virtual line connecting the terminal points of at least one edge line in two edge lines of the grooves with terminated ends. With this arrangement, the hand grooving can be carried out swiftly and easily on the tread surface by utilizing the guide line as a reference to additionally form a groove on the tread surface. As a result, in this pneumatic tire, the groove can be additionally formed swiftly and easily at a desired position in the tread surface. Further, the additional groove can be easily communicated with an existing groove, so that the wet braking performance and the wet cornering performance of the pneumatic tire can be improved.

In the above pneumatic tire, it is preferred that the guide line is a projection having a protruding shape. With the arrangement, the projection disposed on the tread surface is superior in visibility. Therefore, compared to the conventional case, the hand grooving can be carried out more swiftly and easily on the tread surface. Also, with the arrangement, the air remaining between the tread surface and the inner surface of the mold can be discharged more easily during forming and vulcanizing the tire. Therefore, the number of vent holes for discharging the remaining air can be reduced. As a result, it is possible to reduce the number of rubber spews formed correspondingly to the vent holes of the mold during forming and vulcanizing the tire. Furthermore, when carrying out the hand grooving by using a grooving machine, prevented can be such a problem that the grooving machine catches the rubber spews so that the load resistance on the grooving machine increases.

In the above pneumatic tire, it is preferred that the guide line is a concave portion having a recessed shape. With this arrangement, similarly to the above-described projection, the concave portion disposed in the tread surface is superior in visibility. Therefore, compared to the conventional case, the hand grooving can be carried out more swiftly and easily on the tread surface. Furthermore, compared to the case where the hand grooving is carried out by using the projection as the guide line, the additional groove can be formed with more uniform force.

In the above pneumatic tire, it is preferred that the guide line is disposed on a plane same as the tread surface and has a surface roughness different from that of the tread surface. With this arrangement, since the guide line has a surface roughness different from that of the tread surface, similarly to the above-described projection or the concave portion, the guide line is superior in visibility. Accordingly, compared to the conventional case, the hand grooving can be carried out more swiftly and easily on the tread surface. Further, since the guide line is disposed on the same plane as the tread surface, compared to the case where the guide line having a protruding or concave shape is disposed on the tread surface, the tread surface is superior in contact performance with respect to road surface. Therefore, the braking performance on dry road surfaces (hereinafter, referred to as “dry braking performance”) and cornering performance on dry road surfaces (hereinafter, referred to as “dry cornering performance”) tend to be further improved.

The present invention provides a method of carrying out hand grooving on a pneumatic tire having a tread surface formed with a plurality of grooves, wherein the tread surface includes a guide line previously disposed as a reference for carrying out hand grooving, the guide line extending along at least one edge line of the grooves or a virtual extension line of at least one edge line of the grooves.

In the above method of carrying out the hand grooving, the guide line is previously disposed on the tread surface as a reference for carrying out the hand grooving. The guide line extends along at least one edge line of a groove or a virtual extension line of at least one edge line. With this arrangement, the hand grooving can be carried out swiftly and easily on the tread surface by utilizing the guide line as a reference. As a result, in the pneumatic tire, the groove can be additionally formed swiftly and easily at a desired position in the tread surface.

In the above method of carrying out the hand grooving, it is preferred that the guide line is disposed on the virtual extension line. With this arrangement, the additional groove communicated with an existing groove can be formed swiftly and easily at a desired position in the tread surface.

The present invention provides a method of carrying out hand grooving on a pneumatic tire having a tread surface formed with a plurality of grooves, wherein the grooves include two or more grooves each having at least one end terminated within the tread surface, the tread surface has a guide line previously disposed as a reference for carrying out hand grooving, the guide line extending along a virtual line connecting end points of at least one edge line in edge lines of the grooves with terminated ends.

In the above method of carrying out the hand grooving, the guide line is previously disposed on the tread surface as a reference for carrying out the hand grooving. The guide line extends along a virtual line connecting the terminal points of at least one edge line in the edge lines of the grooves with terminated ends. Therefore, the hand grooving can be carried out swiftly and easily on the tread surface by utilizing the guide line as a reference. As a result, in the method of carrying out the hand grooving, it is possible to form swiftly and easily an additional groove communicated with an existing groove at a desired position on the tread surface.

### BRIEF DESCRIPTION OF THE DRAWINGS

FIG. 1 is a perspective view illustrating an example of a tread pattern of a pneumatic tire according to the present invention;

FIG. 2 is an example of a cross sectional view taken along a line I-I as viewed in a direction of arrows I and I in FIG. 1;

FIG. 3 is an example of a cross sectional view taken along the line I-I as viewed in the direction of the arrows I and I in FIG. 1;

FIG. 4 is a perspective view illustrating another example of the tread pattern of the pneumatic tire according to the present invention;

FIG. 5 is a perspective view illustrating another example of the tread pattern of the pneumatic tire according to the present invention; and

FIG. 6 is a perspective view illustrating another example of the tread pattern of the pneumatic tire according to the present invention.

### DETAILED DESCRIPTION OF THE PREFERRED EMBODIMENTS

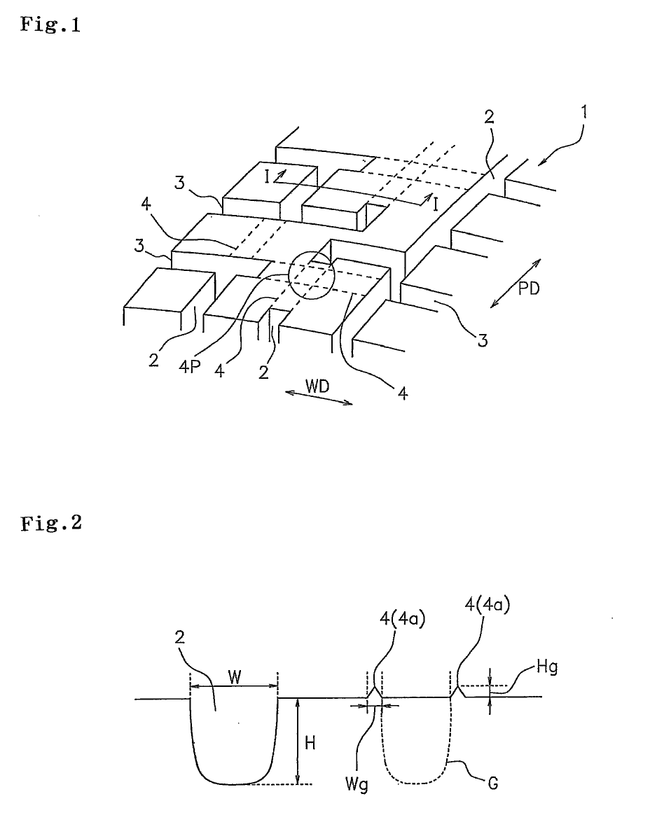

Preferred embodiments of the invention will be described below with reference to the drawings. FIG. 1 is a perspective view illustrating an example of a tread pattern of a pneumatic tire according to the present invention; and FIG. 2 is a view illustrating a cross sectional shape of a guide line taken along a line I-I as viewed in a direction of arrows I and I in FIG. 1. FIG. 1 also indicates a tire peripheral direction PD and a tire width direction WD.

The pneumatic tire of the present embodiment can be used for motor racing. In a case of application to on-road racing, the pneumatic tire can be provided with a tread surface with smaller rubber hardness. In a case of application to off-road racing, the pneumatic tire can be provided with a tread surface with larger rubber hardness. In the present embodiment, the groove area ratio in a tread surface 1 is set to 23%. Considering grooves to be added later in order to cope with various racing situation/course conditions such as a dry or wet road surface, the groove area ratio of the tread surface is preferably set to a range of 10 to 30%.

As shown in FIG. 1, in the pneumatic tire of the present embodiment, the tread surface 1 is formed with a plurality of circumferential grooves 2 that extends in the tire circumferential direction PD and a plurality of lateral grooves 3 that extends in the tire width direction WD. According to the present embodiment, the circumferential grooves 2 include grooves that extend continuously in the tire circumferential direction PD and grooves that extend intermittently in the tire circumferential direction PD (at least one end thereof is terminated). The lateral grooves 3 include grooves that extend intermittently in the tire width direction WD (at least one end thereof is terminated).

As shown in FIG. 1, the pneumatic tire has guide lines 4. The guide lines 4 are previously disposed on virtual extension lines of edge lines extended from two sides of a groove (circumferential groove 2 or lateral groove 3) formed in the tread surface 1. Using these guide lines 4 as a reference, hand grooving can be carried out swiftly and easily on the tread surface 1. As a result, in the pneumatic tire, a circumferential groove 2 or a lateral groove 3 can be additionally formed swiftly and easily at a desired position in the tread surface 1.

The guide lines 4 may be disposed in such a manner that the guide lines 4 forms an intersection of the guide lines 4 extending in the circumferential direction PD with the guide lines 4 extending in the width direction WD as shown in FIG. 1. Alternatively, the guide lines 4 may be disposed in such a manner that, with respect to the guide lines extending in one direction (for example, the circumferential direction PD), the guide lines extending in another direction (for example, the width direction WD) is terminated at the cross-point (not shown).

The method of carrying out the hand grooving include a method in which the groove is formed manually in the plane tread surface 1 by using a tire-groover or the like with respect to the guide lines 4 as a reference.

In the pneumatic tire according to the present embodiment, the guide lines 4 are respectively disposed on virtual extension lines of edge lines extending from the both sides of the circumferential grooves 2 or lateral grooves 3 in the tread surface 1. In this case, a circumferential groove 2 or a lateral groove 3 having a previously determined groove width can be additionally formed swiftly and easily by carrying out the hand grooving between the pair of guide lines 4. As a result, the additional groove can be easily communicated with an existing groove. Therefore, the water discharge performance is remarkably improved, and accordingly, the wet braking performance and the wet cornering performance of the pneumatic tire can be improved.

Each of the guide lines 4 is constituted of a projection 4a having a triangle shape in cross section as shown in FIG. 2. Since the guide line 4 is constituted of the projection 4a, the projection 4a is superior in being recognized on the tread surface 1. As a result, compared to the conventional case, the hand grooving can be carried out further swiftly and easily on the tread surface 1. The depth of the groove formed by carrying out the hand grooving is appropriately selectable depending on the racing/course conditions. In the present embodiment, the groove having substantially the same depth as that of the adjacent circumferential groove 2 is formed as shown with a broken line G in FIG. 2.

Also, since the guide line 4 is constituted of the projection 4a, when the tire is formed and vulcanized, the discharge performance of remaining air existing between the tread surface 1 and an inner face of a mold can be increased. Therefore, the number of vent holes for discharging the remaining air can be reduced. As a result, the number of rubber spews generated correspondingly to the vent holes can be reduced. Further, when carrying out the hand grooving by using a grooving machine, prevented is a problem that the rubber spews caught by the grooving machine causes to increase the load resistance on the grooving machine.

According to the present embodiment, a groove depth H of the circumferential grooves 2 and the lateral grooves 3 is set to 15 mm, and a groove width W thereof is set to 10 mm as shown in FIG. 2. On the other hand, a height Hg of the projection 4a is set to, for example, a range of 0.3 to 1.0 mm, and a width Wg thereof is set to, for example, a range of 0.3 to 0.5 mm. Particularly, the height of the projection 4a is preferably set to a range of 0.5 to 1.0 mm to thereby increase the discharge performance of remaining air during forming and vulcanizing the tire, and thus, the generation ratio of unacceptable tires can be reduced.

According to the present invention, the guide lines 4 may be disposed on the virtual extension lines of the edge lines of at least one of the circumferential grooves 2 and the lateral grooves 3. The number of the guide lines 4 disposed on the tread surface 1 is not limited by the number of the edge lines of the circumferential grooves 2 and/or lateral grooves 3, but may be appropriately selected depending on the expected racing/course conditions.

Also, not all the guide lines have to be used as a reference for the hand grooving correspondingly to the number of the guide lines. The number of the grooves to be formed can be appropriately selected by carrying out the hand grooving depending on the racing/course conditions. Further, the hand grooving may be carried out utilizing a part of the guide line as a reference to terminate the groove on half way of the guide line.

The present invention relates to a pneumatic tire similar to conventional pneumatic tires excepting a point that the guide lines are previously disposed in the tread surface. Therefore, any of conventionally known materials, shapes, structures and manufacturing methods are applicable to the present invention.

Since the grooves can be formed swiftly and easily in the tread surface as described above, the pneumatic tire of the present invention is useful particularly for a pneumatic tire used for motor racing.

### Other Embodiments

(1) The above-described embodiment gives an example in which the respective guide lines are previously disposed on the virtual extension lines of the edge lines extending from the two sides of the groove formed in the tread surface. However, only one guide line may be disposed on a virtual extension line of one edge line of a groove formed in the tread surface. In this case, a method of forming a groove having a constant width and depth by using the guide line as a side-end reference is exemplified as a method of carrying out the hand grooving. Alternatively, one guide line may be disposed so as to extend substantially in the center between the virtual extension lines of two edge lines of the groove formed in the tread surface (not shown). In this case, a method of forming a groove having a constant width and depth by using the guide line as a reference of the center line is exemplified as a method of carrying out the hand grooving.

(2) In the above-described embodiment in which the guide line 4 is constituted of the projection 4a, the projection 4a may have a rubber spew which is formed at a position corresponding to a vent hole of the mold during tire forming and vulcanizing. In this case, the rubber spew is formed on the projection 4a. Therefore, even when the rubber spew is removed after completing the tire formation, the removal trace is invisible. In order to make the removal trace further invisible, the rubber spew on the projection 4a is preferably located on the cross-point 4P of two projections 4a, or on an end of the projection 4a.

(3) The above-described embodiment gives an example in which the guide line 4 is constituted of the projection 4a having a triangle shape as shown in FIG. 2. Alternatively, the projection may have a semicircular shape (not shown).

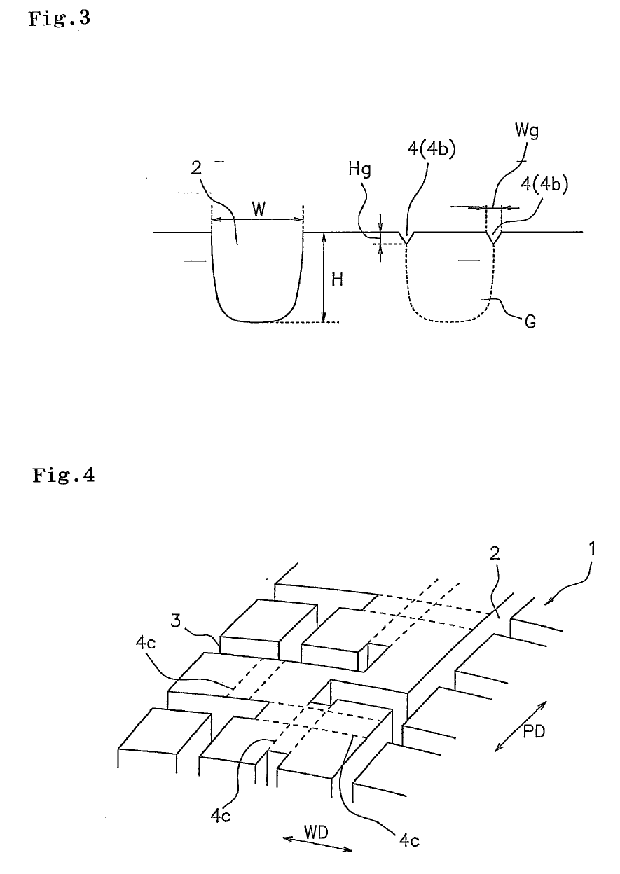

(4) The above-described embodiment gives an example in which the guide line 4 is constituted of the projection 4a having a triangle shape in cross section as shown in FIG. 2. Alternatively, the guide line 4 of the present invention may be constituted of a concave portion 4b having a recessed shape in cross section as shown in FIG. 3 (a view showing a cross sectional shape of the guide line, which is a cross sectional view as viewed in a direction of arrows I and I in FIG. 1). Even in this case, similarly to the above-described projection 4a, satisfactory visibility is obtained. Therefore, compared to the conventional case, the hand grooving can be carried out more swiftly and easily on the tread surface 1. Also, in the present embodiment, the concave portion 4b may have a rubber spew extending from the bottom thereof, which is formed correspondingly to the vent hole of the mold during forming and vulcanizing the tire. In this case, even the rubber spew is removed after completing the tire formation, the removal trace remains in the concave portion 4b, the removal trace is invisible. To make the removal trace further invisible, the position of the rubber spew on concave portion 4b is preferably located on the cross-point 4P of two concave portions 4b or on an end of the concave portion 4b.

(5) The above-described embodiment gives an example in which the guide line 4 is constituted of the projection 4a having a triangle shape as shown in FIG. 2. Alternatively, the guide line 4 may be constituted of a line 4c that is disposed on the same plane as the tread surface 1 and has a surface roughness different from that of the tread surface 1 as shown in FIG. 4, which is a perspective view of the tread surface 1. Even in this case, similarly to the above-described projection 4a and the concave portion 4b, satisfactory visibility is obtained. Accordingly, compared to the conventional case, the hand grooving can be carried out more swiftly and easily on the tread surface 1. Additionally, since the guide line 4 is constituted of the line 4c that is disposed on the same plane as the tread surface 1, compared to the case where the guide line 4 having a projecting or concave shape in the tread surface 1 is disposed, satisfactory contact between the tread surface 1 and the road surface is obtained. Therefore, compared to the conventional case, the dry braking performance and the dry cornering performance tend to be further improved.

As for a method of forming the line 4c that has a surface roughness different from that of the tread surface 1 on the same plane as the tread surface 1, the following method is exemplified. Specifically, the pneumatic tire is formed and vulcanized by using, for example, a forming and vulcanizing mold in which a metal (such as stainless steel) different from a metal (such as aluminum) that constitutes the inner surface of the forming and vulcanizing mold is disposed at an inner position of the mold corresponding to the line 4c on the same plane as the tread surface 1. In this case, the line 4c that has a surface roughness different from that of the remaining tread surface 1 can be formed on the same plane as the tread surface 1 correspondingly to the difference in the surface roughness between the metal disposed at the position corresponding to the line 4c and the metal disposed at the position corresponding to the remaining tread surface 1.

The difference between the surface roughness of the line 4c and the surface roughness of remaining tread surface 1 is preferably 10 μm or more in ten points average roughness (Rz), and more preferably 20 μm or more. In this case, the surface roughness of the line 4c may be rougher or smoother than the surface roughness of the remaining tread surface 1. In the case where the difference in the surface roughness between the line 4c and the remaining tread surface 1 is 10 μm or more in ten points average roughness (Rz), the difference in surface reflection between the line 4c and the other tread surface 1 is increased, so that remarkably preferable visibility is obtained on the guide line.

The above-mentioned “ten points average roughness (Rz)” is a measurement in accordance with the prescription JIS-B0601. Using a needle-touch type surface roughness measure, measurement was made on the design-formed surface. On a roughness curve, a reference length is selected in a direction of the average line. In the selected portion, the average value of the absolute height values of the points from the highest point to the fifth highest point was calculated; and then, the average value of the absolute height values of the points from the lowest point to the fifth lowest point was calculated. The obtained values are added to be expressed by micrometer. In this measurement, the following conditions were set; i.e., reference length L: 0.8 mm, evaluated length; 4 mm, needle end angle: 60°; and front end curvature radius: 2 μm.

In the forming and vulcanizing mold in which a metal (such as stainless steel) different from a metal (such as aluminum) constituting the inner surface of the forming and vulcanizing mold is disposed at a position corresponding to the line 4c on the same plane as the tread surface 1 in the inner surface of the mold, as a method of processing the aluminum surface rougher and the surface of the metal different from aluminum (such as stainless steel) smoother, the following method is exemplified. Specifically, in a state where aluminum and stainless steel are disposed at predetermined positions in the inner surface of the mold, by blowing a blast medium having a Mohs hardness harder than the aluminum and softer than the stainless steel by using a technique like shot blasting, only the softer aluminum surface can be processed to be rougher (to increase the surface roughness). Contrarily, the surface of the stainless steel may be processed rougher and the smoothness of the aluminum surface may be maintained smooth. In this case, by applying a laser or electric discharge machining on surface formed with the stainless steel (this processed surface becomes rougher than that of the non-processed surface), the surface can be processed without additional processing.

Since the line 4c is utilized as a reference for carrying out the hand grooving, satisfactory visibility is required. To improve the visibility, the width of the line 4c (the line width having the surface roughness different from that of the remaining tread surface 1) is preferably set to 0.3 mm or more. When using a forming and vulcanizing mold to form the line 4c, the mold in which a metal (such as stainless steel) different from a metal (such as aluminum) constituting the inner surface of the mold is disposed at a position on the inner surface of the mold corresponding to the line 4c on the same plane as the tread surface 1, the width of the different metal is preferably set to 2 mm or less. When the width of the metal different from the metal constituting the inner surface of the fainting and vulcanizing mold exceeds 2 mm, the difference in the cooling speed between these metals may cause a mechanical failure on the mold itself. In view of this, the width of the line 4c corresponding to the width of the metal (such as stainless steel) different from the metal (such as aluminum) constituting the inner surface of the mold is also preferably set to 2 mm or less.

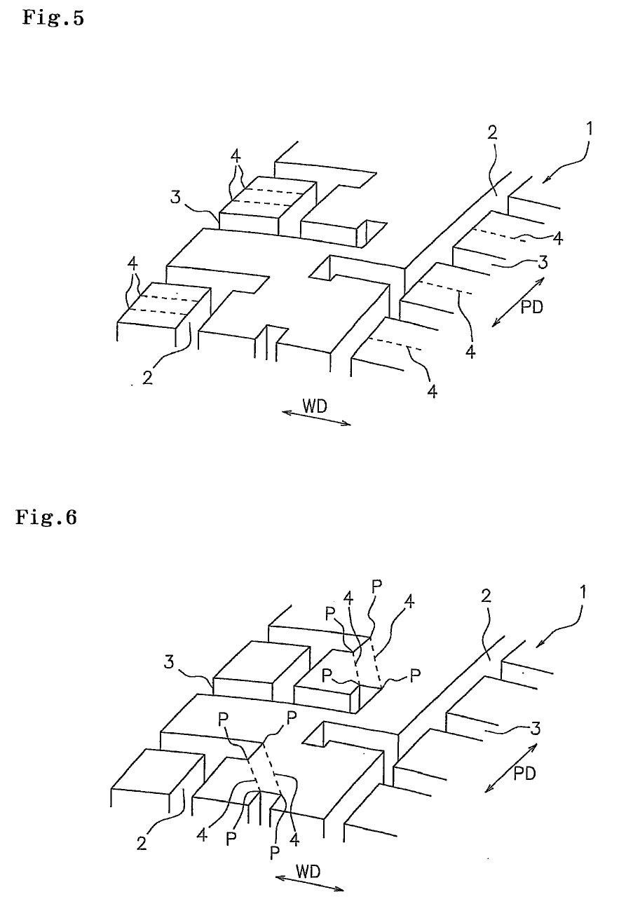

(6) The above-described embodiment gives an example in which the guide lines are previously disposed on the virtual extension lines of two edge lines of the groove formed in the tread surface. Alternatively, a guide line may be disposed to extend along at least one of the edge lines of the groove formed in the tread surface. FIG. 5 illustrates such an example in which the guide lines 4 are previously disposed to extend substantially parallel to each other along the edge lines of the lateral grooves 3. As shown in FIG. 5, in the tread surface 1 of this embodiment, one or two guide lines 4 are previously disposed in a land portion segmented by the adjacent lateral grooves 3.

Furthermore, in the present invention, the guide lines 4 may be previously disposed on the virtual lines each connecting both end points of the edge lines on the two sides of the groove with terminated ends, at least one end of which is terminated within the tread surface 1 as shown in FIG. 6. In this case, the additional groove can be easily communicated with an existing groove. Therefore, the water discharge performance is particularly improved. Accordingly, the wet braking performance and the wet cornering performance of the pneumatic tire can be improved. Alternatively, one guide line may be previously disposed on a virtual line connecting end points of one edge line in two edge lines of the groove with terminated ends (not shown). In this case, as a method of carrying out the hand grooving, the method is exemplified in which a groove having a constant width and depth is formed by utilizing the guide line as a reference of one side end.

What is claimed is:

1. A pneumatic tire comprising:
a tread surface formed with a plurality of grooves, wherein
the tread surface includes a guide line previously disposed as a reference for carrying out hand grooving, the guide line extending along at least one edge line of the grooves or a virtual extension line of at least one edge line of the grooves.

2. The pneumatic tire according to claim 1, wherein the guide line is disposed on the virtual extension line.

3. The pneumatic tire according to claim 1, wherein the guide line is a projection having a protruding shape.

4. The pneumatic tire according to claim 1, wherein the guide line is a concave portion having a recessed shape.

5. The pneumatic tire according to claim 1, wherein the guide line is disposed on a plane same as the tread surface and has a surface roughness different from that of the tread surface.

6. A pneumatic tire comprising:
a tread surface formed with a plurality of grooves, wherein
the grooves include two or more grooves each having at least one end terminated within the tread surface,
the tread surface has a guide line previously disposed as a reference for carrying out hand grooving, the guide line extending along a virtual line connecting end points of at least one edge line in edge lines of the grooves with terminated ends.

7. The pneumatic tire according to claim 6, wherein the guide line is a projection having a protruding shape.

8. The pneumatic tire according to claim 6, wherein the guide line is a concave portion having a recessed shape.

9. The pneumatic tire according to claim 6, wherein the guide line is disposed on a plane same as the tread surface and has a surface roughness different from that of the tread surface.

10. A method of carrying out hand grooving on a pneumatic tire having a tread surface formed with a plurality of grooves, wherein
the tread surface includes a guide line previously disposed as a reference for carrying out hand grooving, the guide line extending along at least one edge line of the grooves or a virtual extension line of at least one edge line of the grooves.

11. The method of carrying out hand grooving according to claim 10, wherein the guide line is disposed on the virtual extension line.

12. A method of carrying out hand grooving on a pneumatic tire having a tread surface formed with a plurality of grooves, wherein
the grooves include two or more grooves each having at least one end terminated within the tread surface,
the tread surface has a guide line previously disposed as a reference for carrying out hand grooving, the guide line extending along a virtual line connecting end points of at least one edge line in edge lines of the grooves with terminated ends.
